(19) United States
(12) Patent Application Publication
(10) Pub. No.: US 2008/0134042 A1
(43) Pub. Date: Jun. 5, 2008

(54) Qkd System Wth Ambiguous Control

(75) Inventor: Paul Jankovich, Northborough, MA (US)

Correspondence Address: OPTICUS IP LAW, PLLC, 7791 ALISTER MACKENZIE DRIVE, SARASOTA, FL, 34240, US

(73) Assignee: Magiq Technologies, Dac , a corporation

(21) Appl. No.: 11/662,989

(22) PCT Filed: Sep. 14, 2005
(86) PCT No.: PCT/US2005/032593

§ 371 Date: Nov. 9, 2007

(51) Int. Cl. G06F 3/00

(52) U.S. Cl. 715/733

(57) ABSTRACT

Methods and apparatus for automatically generating a list of recommended links for a user are disclosed. For a particular user, one or more criteria for use in generating a list of recommended links are identified or selected by the user. A list of one or more recommended links is then generated and provided to the user.

### FIELD OF THE INVENTION

The present invention relates to methods and apparatus for automatically generating recommended links. More particularly, the present invention relates to the collection of data associated with web activities and the automatic generation of recommended links based upon the collected data.

### BACKGROUND OF THE INVENTION

The Internet has recently become a popular information resource for even the most unsophisticated computer user. The popularity of the Internet as an information source is due, in part, to the vast amount of available information that can be downloaded by almost anyone having access to a computer and a connection. However, the enormous amount of information that is available on the Internet can make it difficult to locate specific information on a given topic.

While the amount of information accessible via the Internet is daunting, users often return to the same website on a regular basis. In order to reduce the time it takes to access a given website, a user may choose to create a readily-accessible link to the website by adding a “bookmark” to a bookmark list. A bookmark is a saved hyperlink to a website or web page. By adding a link to a website or web page to the user's bookmark list, the user may quickly and easily return to the website or web page via the saved link.

While a user always has the option to add a particular website or web page as a bookmark, most users generally do not have the time to regularly research additional websites other than those that they already frequently access. As a result, users tend to repeatedly use the same websites that they have previously visited. Since it is easier to return to websites that they have previously accessed, users often remain unaware of other similar or newly created websites that may be of interest to them. In view of the above, it would be beneficial to provide improved mechanisms for introducing websites or web pages that may be of interest to a user.

### SUMMARY OF THE INVENTION

To achieve the foregoing and other objects of the invention, a variety of methods for providing recommended links to a user are described. In one aspect of the invention, a plurality of recommended links agents are executed. Each of the recommended links agents is adapted to identify a list of links that may be provided to the user as recommended links in an associated class of recommendations. The various recommended links agents may be executed at any appropriate time. For example, they may be run on a periodic basis (e.g., once an hour, once a day, once a week, etc.) or they may be executed on demand (e.g., when a particular host website is accessed, when a browser is opened, or upon request from a user). Once determined, the recommended links may be provided to a user in any suitable form or format. For example, the recommended links may be provided to the user via one (or more) of a web page accessed by the user, an e-mail message, as part of a list of bookmarks associated with the user, and/or as a feature of a toolbar, etc. In some embodiments, the recommended links are arranged in a plurality of different classes of recommendations.

A “recommended link” may take the form of any mechanism that is suitable for identifying (and preferably accessing) a specific recommended website or web page. By way of example, a recommended link may include, but is not limited to, a hypertext link, a URL representing a web page or website or any other mechanism.

In various independent aspects of the invention, recommended links agents may be arranged to recommend links based upon a wide variety of criteria and/or heuristics. In the following discussion, a variety of different agents are described. The agents may be used independently, or in conjunction with a system that obtains recommendations from multiple agents.

One type of recommended links agent is arranged to recommend links to websites that are believed to be similar to one or more websites that the user has previously visited (or is currently visiting). Such agents may operate using a variety of different heuristics. For example, in some implementations, the agent may be arranged to review the user's browsing history any identify websites that the user has previously visited. The agent then identifies other websites that are perceived to be similar to the visited websites and presents a set of theses similar websites to the user as recommended links.

In another embodiment, a recommended links agent is arranged to recommend links to websites that the user has “frequently” visited within a specified period of time. In such a system the actual number of visits that a user would need to visit a site to be considered “frequent” may be widely varied and/or may be a function of the browsing habits of the user. For example, a “frequently” visited site for a heavy web user may require more visits than a “frequently” visited site for a light web user.

In accordance with another aspect of the invention, a list of recommended links that has been generated for use by one user may be provided to another user. Similarly, a list of bookmarks maintained by one user may be provided to another user as recommended links. This may be desirable, for instance, if a user wishes to provide access to his or her links to friends or relatives. Moreover, it may be desirable to provide a “link of the day,” which enables others to view a particular list of bookmarks of a particular user.

In accordance with another aspect of the invention, links that are recommended to the user may be filtered. For example, a link that has already been added to the user's list of bookmarks need not be recommended to the user and therefore may be filtered from a list of recommended links. In another example, a link that the user has previously declined to add to the user's list of bookmarks is not recommended to the user. In another example, an agent that is designed to recommend links referring to websites or web pages that are visited frequently by the user, those sites that are merely “link” sites or the user's home page may be identified and eliminated from the recommended list of links.

In accordance with yet another aspect of the invention, recommendations provided to a user may be time-segmented. For instance, web activities of the user (or a specific group of users) at a particular time may be used to generate a list of recommended links. As one example, the time specified may be morning, afternoon, evening, or late night. As another example, the time specified may be hourly, during the weekdays, during the weekend, during annual holidays, or during periodic sporting events such as the Olympics or the games of a particular baseball or soccer team. Moreover, a time period for which data is gathered (e.g., a period of weeks, months or years) will generally be used in order to retrieve the pertinent data, as well as limit the amount of data that is retrieved.

In accordance with yet another aspect of the invention, a user may wish to receive recommendations associated with a particular subject. In other words, the user may wish to receive recommendations that are content-based. For instance, a user may wish to receive recommendations related to news, movies, stocks, traffic, or sports. Similarly, a user may wish to receive notification of links referring to websites having (or not having) a particular adult content or rating. For instance, the user may be interested in websites that are not R-rated or X-rated.

In accordance with yet another aspect of the invention, web activities of individuals other than the user may be used to compile a list of recommended links. As one example, the web activities of a group of users with which the user identifies may be monitored in order to provide a suitable list of recommendations to the user.

As another example, a user may wish to be notified of bookmarks that the group of users or individuals in that group have selected. This group of users may, for example, be the user's family, the user's friends, co-workers, or those in club or association to which the user belongs.

In accordance with yet another aspect of the invention, web activities of similarly situated individuals (or bookmarks selected by those individuals) may be used to compile a list of recommended links for a particular user. Those who are similarly situated may, for example, be individuals within a particular geographic region, or those having a particular set of personal characteristics such as gender, age, employment status, race, etc., those with similar shopping behavior or similar browsing behaviors, and/or any of a wide variety of other similarities. A geographic region may include an entire state or city, or may simply be defined by a particular zip code or set of zip codes. Similarly, a group of similarly situated individuals may simply be individuals who access a number of the same Uniform Resource Locators (URLs), similar URLs or purchase some of the same products (or services).

In accordance with yet another aspect of the invention, those websites that are considered “movers and shakers” may be provided to the user as recommended links. A website may be considered a “mover and shaker,” for example, if it has gained popularity among a number of users. Similarly, a website may be considered a “mover and shaker” if it is accessed with a particular frequency during a particular period of time.

In accordance with yet another aspect of the invention, links that are bookmarked by the user or another group of individuals may be used to generate a list of recommended links. For instance, a user may be interested in bookmarks that have been created by family members or friends. These bookmarks may be bookmarks that have been selected from a list of recommended bookmarks, or they may be bookmarks that have been independently selected by the user.

As described above, there are a number of criteria that may be used to generate a list of recommended links. These criteria may be applied individually or in combination with one another. In accordance with one embodiment, the “intersection” of two different lists of recommended links may be identified in order to generate a recommended list of websites based upon multiple criteria. In accordance with another embodiment, each criterion may be used to generate a separate recommended link list. For instance, a recommended list of “morning links” and a recommended list of “evening links” may be generated for a single user.

In accordance with yet another aspect of the invention, each criterion or combination thereof may be selectable by a user. In accordance with one embodiment, each criterion may be used separately or in combination with other criteria to generate a list of recommended links via an agent implementing this criterion. Thus, the user may select the agent or agents that the user wishes to execute to generate his or her recommended list(s) of links. From a particular list of recommended links, the user may then select those links that are desired as bookmarks. These selected links may then be “transferred” to a list of bookmarks associated with the user and removed from the list of recommended links.

The embodiments of the invention may be implemented software, hardware, or a combination of hardware and software. The invention can also be embodied as computer readable code on a computer readable medium. In addition, data structures disclosed are also part of the invention.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is an exemplary graphical user interface suitable for presenting recommended links to a user in accordance with one embodiment of the invention.

FIG. 1B is an exemplary graphical user interface suitable for presenting recommended links to a user in accordance with a second embodiment of the invention.

FIG. 1C is an exemplary graphical user interface suitable for presenting recommended links to a user in accordance with a second embodiment of the invention.

FIG. 2 is a system block diagram illustrating an exemplary system in which embodiments of the invention may be implemented.

FIG. 3A is a process flow diagram illustrating a method of executing multiple agents by a workflow manager such as that shown in FIG. 2 in accordance with one embodiment of the invention.

FIG. 3B is a process flow diagram illustrating an alternate method of executing multiple agents by a workflow manager such as that shown in FIG. 2 in accordance with another embodiment of the invention.

FIG. 3C is a process flow diagram illustrating a method of executing an agent as shown at block 434 of FIG. 3B.

FIG. 4 is a process flow diagram illustrating a method of filtering auto-generated recommended bookmarks as shown at block 418 of FIG. 3A.

FIG. 5A is a diagram illustrating an exemplary URL table that may be used to store website visitation data in accordance with one embodiment of the invention.

FIG. 5B is a diagram illustrating an exemplary URL summary table composed from multiple URL tables in accordance with one embodiment of the invention.

FIG. 6A is a diagram illustrating an exemplary user table that may be used to store data associated with a user in accordance with one embodiment of the invention.

FIG. 6B is a diagram illustrating an exemplary user summary table composed from multiple user tables in accordance with one embodiment of the invention.

FIG. 6C is a diagram illustrating an exemplary user record including personal information associated with a user.

FIG. 7 is a diagram illustrating an exemplary system in which the present invention may be implemented.

### DETAILED DESCRIPTION OF THE PREFERRED EMBODIMENT

In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

One of the challenges facing Internet users is identifying content that might be of interest. There are a variety of ways that users may come across information of interest. One way that a user may learn of a website is through the personal recommendation of an acquaintance. Although recommended sites may be of particular interest to a user, in most situations, personal recommendations are made on an ad hoc basis and therefore somewhat limited in their usefulness. In one aspect, the present invention seeks to provide automated mechanisms for recommending sites that may be of interest to a user. Embodiments of the invention enable a set of websites, web pages, or resources (which may be represented by a URL, hyperlink, or other mapping technique) to be recommended to a user as recommended links.

There are a wide variety of categories and types of information that might be of interest to a user. Therefore, a wide variety of heuristics may be used to obtain the recommended links. For example, if a user has looked at several websites that can be categorized in a particular field or category of information, it may be useful to present the user with recommended links to other popular websites within that field. In another example, if a user regularly visits a particular website, it might be useful to provide direct links to those sites among the recommended links. Such recommendations might be time or context sensitive. For example, if a user regularly checks one set of specific sites on weekday mornings and another set of specific sites in the evenings, it might be most useful to include the sites that are normally checked in the morning among the recommended links when they are presented in the morning, but not in the evening.

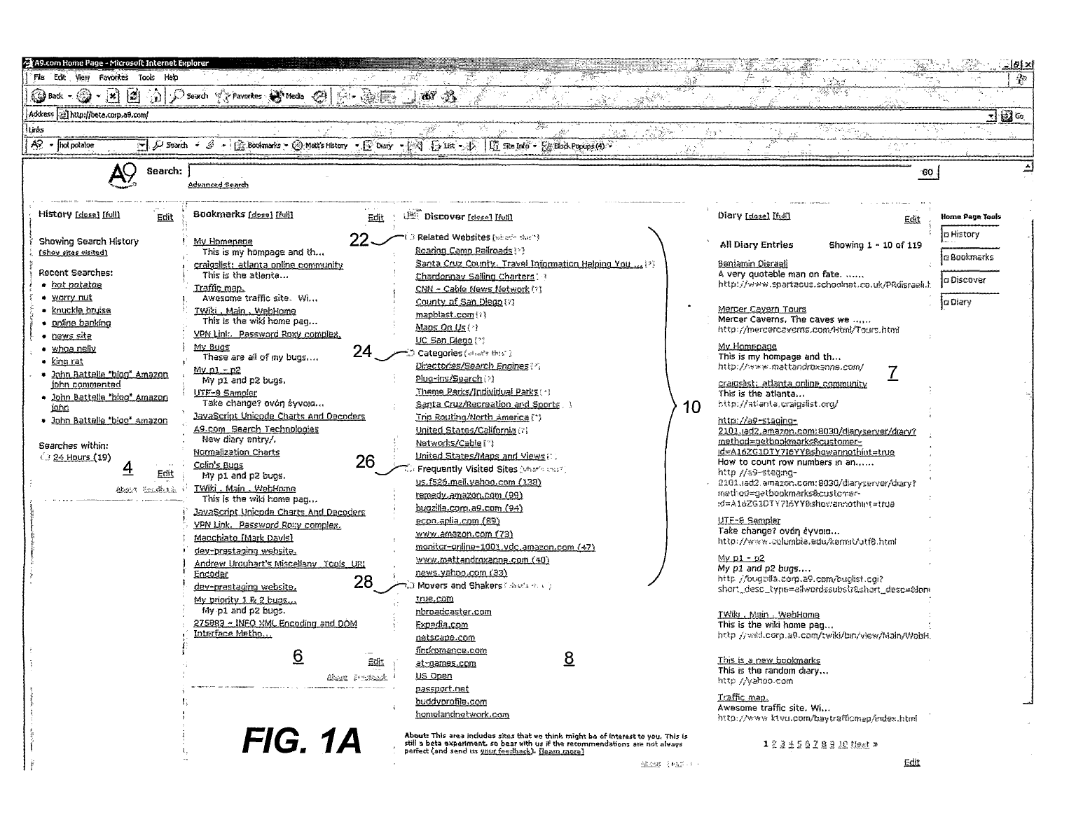

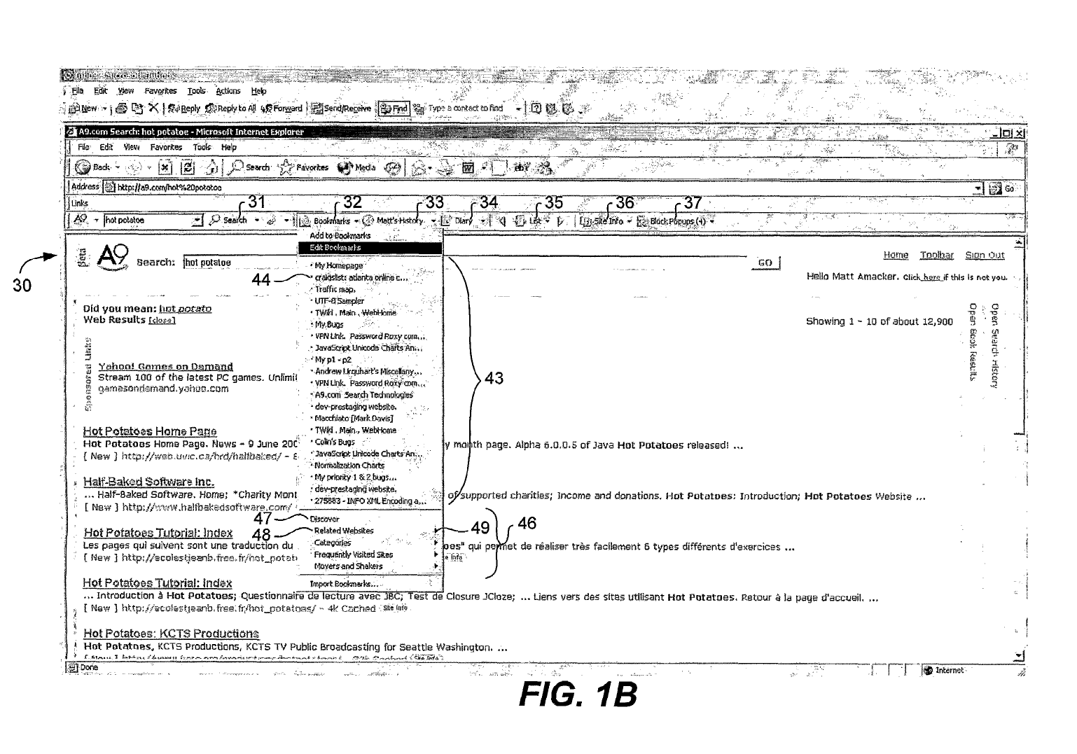

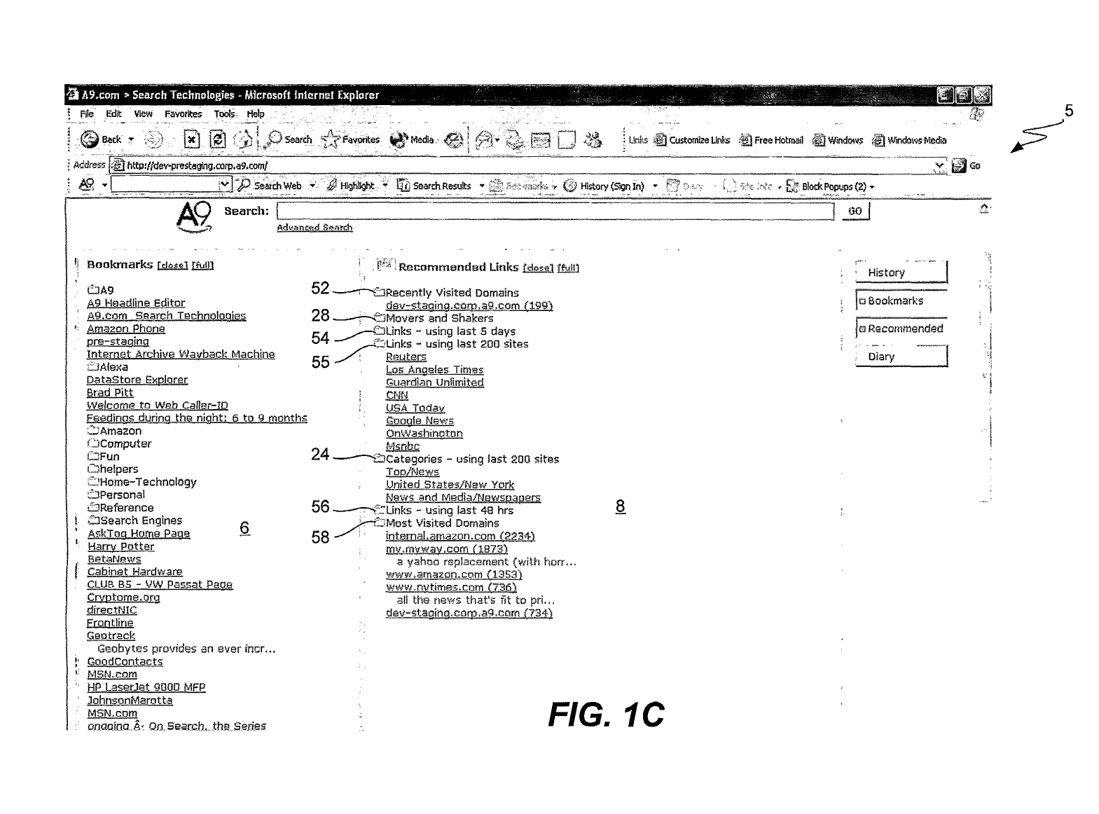

FIG. 1A is an exemplary graphical user interface for presenting bookmarks and recommended links to a user in accordance with one embodiment of the invention. In the illustrated embodiment, the graphical user interface includes a multi-paned display window 5. This multi-paned display window 5 is described in some detail in co-pending application Ser. No. 10/934,822, filed Sep. 2, 2004, which is incorporated herein by reference. In the illustrated state, the window 5 includes a search entry dialog box 104 for receiving search terms and a number of panes that display different types of content that may be useful to a user that is looking for particular information. The different panes include a search history pane 4, a bookmark pane 6, a recommended links pane 8 and a diary pane 9. The search history pane 6 presents a history of searches that have previously been conducted by the user. The bookmark pane 6 presents a list of bookmarks 20 that have previously been created by the user. The Diary pane 7 presents search results and potentially other information that have been saved by the user. The recommended links pane 8 includes a recommended links section 10 (which in the illustrated embodiment are organized in folders) that presents a number of hyperlinks to web pages, websites or other information that might be of interest to the user. The recommended links that are provided in the recommended links section 10 may be organized in any suitable manner.

In the illustrated embodiment, there are four classes of recommendations, each of which are represented by an associated folder. Each class of recommendations is associated with a particular “agent” that (as described in more detail below) is responsible for generating the associated recommendations. Of course, in other implementations, a wide variety of other classes of recommendations may be presented and/or any of the illustrated classes may be omitted. Alternatively, or in addition to the illustrated folders, some of the recommended links may be listed sequentially instead of hierarchically. Of course GUI widgets other than folders may be used to represent classes or groups of recommended links.

In the illustrated embodiment, the four classes of recommendations include: Related Websites 22; Related Categories 24; Frequently Visited Sites 26; and Movers & Shakers 28. Generally, the “Related Websites” Agent is arranged to analyze a user's browsing history to identify websites that are perceived to be related to websites the user has recently visited. This may be accomplished by tracking a history of websites that the user has visited and then identifying other sites that are believed to be “related” to the websites that have been visited. If a particular website is related to more than one of the sites that the user has recently visited, then it may be of interest to the user. The “Related Websites” Agent is arranged to analyze the sites that are related to sites that the user has visited and formulate recommended links based at least in part upon how many times a particular website is identified as being related to one of the sites that the user has previously visited.

As will be described in more detail below, there are currently a number of toolbars and other agents that are arranged to track an Internets user's browsing history. For example, some toolbars are arranged to transmit an identification of every page turn that a user makes while browsing the Internet to a browsing history database server. One such toolbar is the Alexa toolbar available from Alexa Internet Inc. (Alexa). There are also a number of services that seek to categorize websites and to identify related links. Some mechanisms for identifying related links are described in U.S. Pat. No. 6,691,163, entitled “Use of Web Usage Trail Data to Identify Related Links,” which is incorporated herein by reference in its entirety. One commercially available service that identifies related sites is provided by Alexa which categorizes related sites based upon the DMOZ.org categorization of websites.

The “Related Websites” agent is arranged to query a browse history database to identify each site that the user has visited during a designated time period (or other appropriate grouping). For each site the user visited, the “Related Websites” agent retrieves a set of “related” sites from a related sites database. The number of entries retrieved in the set of related sites may be widely varied based on the needs of a particular application. By way of example, in one specific implementation, a set of 10 related sites may be retrieved from the related sites database.

In accordance with one embodiment, each related site is scored by the “Related Websites” agent according to selected criteria. In the described embodiment, each related site first receives a “Relation-score.” A Relation-score may be obtained from a third party service. Second, the number of different sites visited by the user that refer to the same related site is ascertained. Third, the number of times the user has visited each visited site is ascertained from the history database. Then an appropriate scoring algorithm is used to rate the sites. For instance, a scoring algorithm that may be used by the Related Websites Agent is:

Score=sum(Relation-score*log 2(1+visit-count)), where the sum is the sum over all visited sites that resulted in the recommended site, Relation-score is the relevancy score of the recommendation for the visited site returned by the third party service, and visit-count is the number of times that the user visited the site, and Score is the final score assigned to the recommended site. From these scores, the related websites may be ranked in order to provide a set of recommended related websites with the highest scores. Hyperlinks that link to the recommended websites are then created and referenced in the Related Websites folder 22.

The second class of recommendations illustrated in FIG. 1A is associated with the “Categories” folder 24. The Categories folder 24 is arranged to identify Categories of websites (or more generally information) that may of interest to the user. Like the Related Websites Agent, the “Related Categories” agent examines a user's browsing history. However, rather than attempting to identify related websites, the Related Categories Agent attempts to identify related categories of information that are perceived to be related to websites that the user has recently visited. Again, there are a number of services available that attempt to categorize websites in accordance with a particular categorization scheme. In the described embodiments, the categories are provided by a third party service (which uses the DMOZ.org categorization scheme). From the history database, the “Related Categories” agent identifies each site the user visits. For each site the user visits, the “Related Categories” agent retrieves a set of related categories from an appropriate related categories database. The number of entries in the set of related categories may be widely varied based on the needs of a particular application. By way of example, in one specific implementation, a set of 10 related categories is retrieved from the related sites database.

In one particular implementation, each related category is scored by the “Related Categories” Agent according to three criteria. First, each related category receives a Relation-score. Again, such Relationship scores are available from the third party service. Second, the number of different sites visited by the user that are within the related category is ascertained. Third, the number of times the user has visited each visited site is ascertained from the history database. By way of example, one suitable scoring algorithm that may be used by the Related Categories Agent is:

Score=sum(Relation-score*log 2(1+visit-count)), where the sum is the sum over all visited sites that were associated with the recommended category, the Relation-score is the relevancy score of the recommendation for the visited site returned by the third party service, visit-count is the number of times that the user visited the site, and Score is the final score assigned to the recommended category. From these scores, the related categories may be ranked in order to return a set of categories with the highest scores.

The third class of recommendations is associated with the “Frequently Visited Sites” folder 26. The “Frequently Visited Sites” folder 26 is arranged to provide a list of websites that the user has most frequently visited. Thus, the Frequently Visited Sites Agent is arranged to track the browsing history to identify the web pages or websites that the user has most frequently visited during a defined period of time or over a designated number of most recent visits (e.g., the 100 or 1000 most recent page turns or website visited). The most visited sites are presented as recommended links in the Frequently Visited Sites folder 26.

The fourth class of recommendations is associated with the “Movers and Shakers” folder 28. The Movers & Shakers folder 28 is arranged to provide a list of websites that are categorized as “movers and shakers.” Specifically, a website categorized as a “mover and shaker” is a website that is increasing (or decreasing) in popularity at a rapid rate. By way of example, one technique for generating a list of websites that are categorized as “Movers and Shakers” is disclosed in patent application Ser. No. 10/050,579, entitled “Web You Made,” filed on Jan. 5, 2002, which is incorporated herein by reference for all purposes. The techniques may be applied to the web as a whole in order to identify general websites that may be of interest to all users. Alternatively, the techniques may be applied to categories of websites related to the user's browsing history in order to identify interesting websites in categories that may be of particular interest to the user.

In the embodiment illustrated in FIG. 1A, the recommendations are presented as part of a web page that a user may access in order to use any of a number of searching and information gathering tools. However, it should be appreciated that the list of recommended links may be provided to the user using any appropriate interface or mechanism. By way of example, in alternative embodiments, the results could be presented as a function of a toolbar installed on the user's computer, as part of a software application, or via electronic mail. FIG. 1B illustrates a toolbar that is configured to present the recommended links. In this embodiment, a toolbar 30 has a number of buttons 31-37 that represent different functionalities that can be performed by the toolbar. The recommended links are presented in a pull down menu 41 that is accessed by selecting bookmarks button 33. The pull down menu 41 includes a bookmark section 43 and a recommended links section 46. The bookmark section 43 includes a number of bookmarks 44 that have been saved by the user. In the illustrated embodiment, the bookmark section 43 is presented as a series of hyperlinks to sites that have been saved by the user. In other embodiments, hierarchical folders may be used to store some or all of the bookmarks. The recommended links section 46 includes a title entry 47. In the illustrated embodiment, the title entry 47 reads “Discover”, although in other implementations other labels, as for example, “Recommended Links” etc. may be used. The recommended links section 46 also lists the available classes of recommendations. In the illustrated embodiment, the same four classes of recommendations that were described above with respect to FIG. 1A are presented. Each of the available classes of recommendations has an associated arrow 49 that when selected presents the associated list of recommendations in a pull down menu (not shown). The described embodiments generally refer to recommended links as hyperlinks to recommended websites or web pages. However, these examples are merely illustrative. The list of recommended links may include URLs, hypertext links to accessible locations other than websites, and/or links created using any other link mapping or addressing technique. They may also reference categories of information (as in the Recommended Categories example) or groups of links, terms or other information that is believed to be of potential interest to the user. The order that recommendations are presented to the user may also be widely varied to accommodate any presentation scheme that is perceived to be of interest to the user.

FIG. 1C illustrates another graphical user interface suitable for rendering recommended links in accordance with another embodiment of the invention. In this embodiment, the recommended links section 10 has a few different classes of recommendations. The recommendations are again presented hierarchically using folders that each relate to specific classes of recommendations. In the illustrated embodiment, seven classes of recommendations are provided. These include Recently Visited Domains 52, Movers and Shakers 28, three different types of Related Website Recommendations 54, 55, 56 (labeled “Links” in the Figure), Related Categories 24 and Most Visited Domains 58.

The Recently Visited Domains folder 52 simply provides links to websites that have been most recently visited by the user. These recommended links may simply be a list of a specific number of links that were most recently visited (e.g. the 10 most recently visited websites) or a list of the links that were viewed over a designated time period (e.g., within the last 6 hours) or a combination of the two (e.g., the 10 most recently visited websites, so long as they were viewed in the last 48 hours). Of course the number of recently visited sites that are displayed and/or the designated time period from which the sites are defined as “recent” may be widely varied. In some implementations, the user may be given control over these variables.

The Movers & Shakers folder 28 and the Related Categories folder 24 operate the same as described above with respect to FIG. 1A. As can be seen in the title that accompanies Related Categories folder 24, the determination of related categories is based on an analysis of the last 200 websites that the user has visited. Of course, the number of recently visited websites that are analyzed may be widely varied.

The Most Visited Domains folder 58 presents links to the websites that the user has visited most frequently over the user's stored browsing history. These results may be provided by the Frequently Visited Sites Agent discussed above with respect to FIG. 1A. In this implementation, the Frequently Visited Sites Agent determines the number of times a user has visited each website in the entire stored browsing history and provides links to those sites that have been most frequently visited. In some situations, it may be desirable to filter some of the most frequently visited sites. For example, in some situations, it may be desirable to remove websites that are universally popular sites such as Yahoo from any recommended links. In other implementations it may be desirable to analyze the time spent at a particular URL by a user. When the time spent is less than a threshold time period, that URL may be either a home page or a “link” site, which is not of particular interest to the user. It may also be desirable to monitor other selections by the user, such as the frequency of back-button navigations, to help estimate the relevance of specific sites. Similarly, it may be desirable to filter sites that are perceived to relate to a user's e-mail account.

The folders 54, 55 and 56, which are each labeled “Links,” present recommendations provided by the Related Websites Agent discussed above with respect to FIG. 1A. The differences relate to the number of recently accessed websites that are analyzed in providing the recommendations. Folder 54 presents recommended links based on an analysis of websites that were visited during the last 5 days. Folder 55 presents recommended links based on an analysis of the last 200 websites that were visited. Folder 56 presents recommended links based on an analysis of websites that were visited during the last 2 days. Of course, the number of and/or time period of the historically accessed websites that are analyzed by the Related Websites Agent (or any of the other Agents that are based in part on a review of the browsing history) can be widely varied and the interface may be designed to present the results based on any group size that is believed to present useful recommendations. It should be apparent that for most users, the specific recommended links are likely to vary somewhat based on how far back the Agents look into the user's browse history.

In the embodiments illustrated in FIGS. 1A-1C, a bookmark list is provided in close proximity to the recommended links. This allows a user to easily add entries from the recommended links list to the bookmark list. The transfer of links from the recommended links list to the bookmarks list may be performed using any appropriate content moving gesture, as for example, via a drag-and-drop operation, a cut and paste operation or the like.

In some embodiments, it may be desirable to allow the user to block certain recommended links. Blocking may be accomplished using a variety of different gestures. By way of example, the interface could be configured to block a particular link from appearing in the recommended links list by selecting (highlighting) a particular link and pressing the delete key. In other embodiments, a user may block a recommended link, by moving the recommended link from the recommended link list 106 to an icon or a container that contains a list of blocked links (not shown). In this manner, a user may permanently block or remove a particular link from appearing in the recommended link list 106. A user may later choose to modify the block list of links by deleting any entries from the block list of links through standard operations. A user may also wish to preemptively block a particular link that has not yet been recommended to the user by manually entering the link (or otherwise specifying that the link be added) into the list of blocked links.

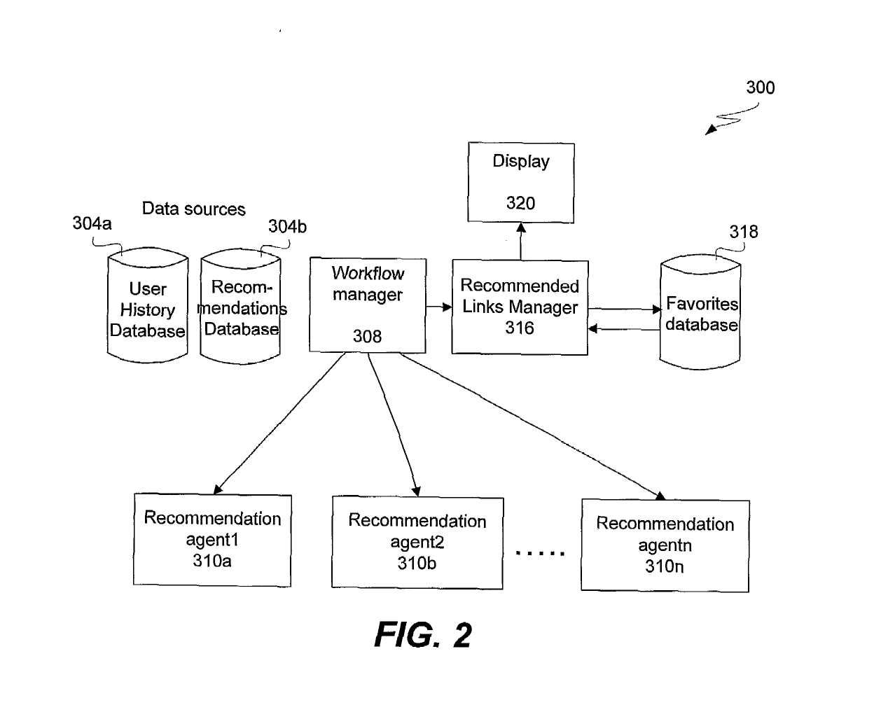

Referring next to FIG. 2 an exemplary system 300 for implementing selected embodiments of the invention will be described. The system includes a workflow manager 308, a plurality of Recommendation Agents 310, a variety of databases 304 that may be accessed by the Recommendation Agents and/or the workflow manager, and a recommended links manager 316.

Each Recommendation Agent 310 is arranged to generate a set of recommended links for a particular user based on a specific set of heuristics. By way of example, to support the embodiment illustrated in FIG. 1A, the system would include a Related Websites Agent, a Related Categories Agent, a Frequently Visited Sites Agent and a Movers and Shakers Agent. In general (as will be discussed in more detail below), it is contemplated that a wide variety of other Agents may be used to generate other classes of recommendations as well. As previously described, the various agents may need to access any of a number of relevant databases in order to generate their associated recommendations. In the illustrated embodiment, the accessible databases include a customer history database 304(a), a recommendations database 304(b) and any other relevant databases.

Workflow manager 308 coordinates the process by which recommendations are generated. In order to obtain the recommended links for a particular user, the workflow manager 308 may be arranged to call one or more of the agents 310 passing the information that the Agent needs to make its recommendations. Each Agent is arranged to generate a list of recommended links for each particular user. In some implementations, all of the users will be presented with the same classes of recommended links. In these cases, the workflow manager 308 may be configured to call all of the agents for every user. However, in other implementations, the classes of recommendations may be context sensitive and therefore selected by the system, or the user may be given control over the classes of recommendations that will be provided. In these embodiments, the workflow manager may only call selected agents 310.

The workflow manager 308 may be arranged to manage the order in which the agents are executed. In some instances, it may be desirable to control the order in which the Agents are executed in order to avoid duplicate processing. Specific ordering of the agents may also be desirable when an agent is dependent upon the processing or output of one or more other agents. This may be accomplished through the use of a tree or other suitable data structure to manage the execution order of multiple agents.

Once a list of recommended links has been generated by an agent or combination of agents, the list of recommended links is provided by the workflow manager 308 to the recommended links manager 316. The recommended links manager 316 stores the recommended links in a database 318. The recommended links manager 316 is also responsible for serving the recommended links at the appropriate time. In embodiments where the recommended links are served as part of a web page (as illustrated in FIG. 1A), the recommended links manager 316 will deliver the recommended links in response to an access request from either the user's browser or from a web server responsible for the content delivered for a particular web page.

In the illustrated embodiment, the workflow manager 308 and recommended links manager 316 are illustrated as separate modules. However in alternative embodiments, the workflow manager 308 and recommended links manager 316 may also be implemented as a single unit.

The recommended links may be generated in real-time when the user accesses a central website or a particular feature of a website. Alternatively, these links may be generated in batch mode. For example, it may be desirable to generate a list of recommended links for various sets of users in different batches. Depending upon the criteria used to generate the list of recommended links, it may be desirable to generate or update a list of recommended links for some users every day, and generate or update a list of recommended links for other users every week.

Data may be obtained from one or more of the data sources directly by any of the agents 310a, 310b, . . . 310n using that data. Alternatively, the data may be obtained by the workflow manager 308 or the recommended links manager 316 to be transmitted to the appropriate agent(s). For instance, data that is used universally by multiple agents may be transmitted to those agents, while data specific to one or more agents may be retrieved directly by the agents using that specific data. In accordance with one embodiment, the recommended links manager 316 obtains the data from the history database 304(a) to be provided to each of the agents 310a, 310b, . . . 310n, while the appropriate agent or agents obtain recommended links directly from the recommendations database 306(b). The agents then process the data, as appropriate.

Agent processing may simply involve receiving recommended links or categories thereof from the recommendations database 304(b) and providing these to the user. For instance, the most popular websites (i.e., Movers and Shakers) may be obtained from the database without further processing. Alternatively, the processing may involve processing data obtained from the history database and/or the recommendations database prior to providing recommended links to the user. For instance, in order to identify the most visited domains (and to thereby generate a list of recommended links based on these domains), a list of website domains that a user has visited the most may be identified from the history database.

In order to generate a list of recommended links, most of the Agents will need to utilize information stored in one of the accessible databases. One database that has been frequently referenced in this application is a customer browsing history database 304(a), which stores data associated with the web activities of a number of users over time. One example of a system for generating and maintaining a history database 304(a) is disclosed in patent application Ser. No. 10/612,395, entitled “Server Architecture and Methods for Persistently Storing and Serving Event Data,” which is incorporated herein by reference.

In accordance with one embodiment, the data associated with the web activities of a user that is stored in the history database 304 is obtained via a toolbar that has been installed on the user's computer. By way of example, a toolbar capable of sending data back to a server, is disclosed in U.S. Pat. No. 6,282,548, entitled “Automatically Generate and Displaying Metadata as Supplemental Information Concurrently with the Web Page, There Being No Link Between Web Page and Metadata” and assigned to Alexa Internet, which is incorporated herein by reference. The data that is received from the toolbar may include, for example, a user identifier (e.g., account number of the user) and/or a toolbar identifier associated with the toolbar, a URL being visited, and a timestamp. Activity may be tracked on a toolbar basis (in which case multiple people using the same computer could have their activity aggregated, or one user using two different computers could have two histories) or on a user basis (if the toolbar or a corresponding website supports log-on functionality to allow identification of a particular user using the computer). The data that is transmitted by the toolbar may be transmitted on a periodic basis or each time a website or web page is accessed via the toolbar.

While the toolbar is one way in which information associated with a user's web activity may be collected, it is important to note that other mechanisms for collecting data corresponding to a user's web activities are possible. For instance, data associated with a user's web activity may be captured via a server when a user accesses websites through the server.

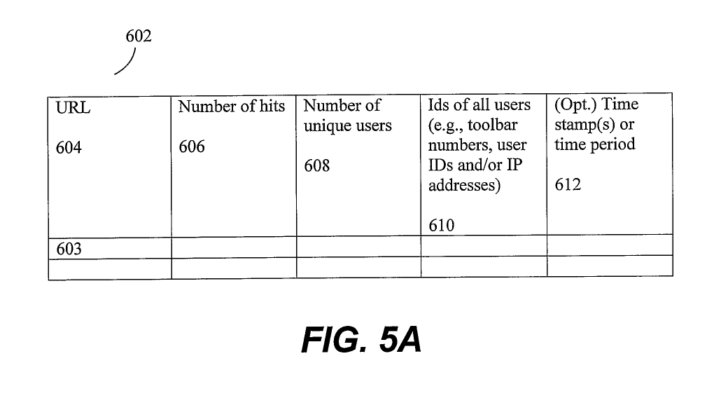

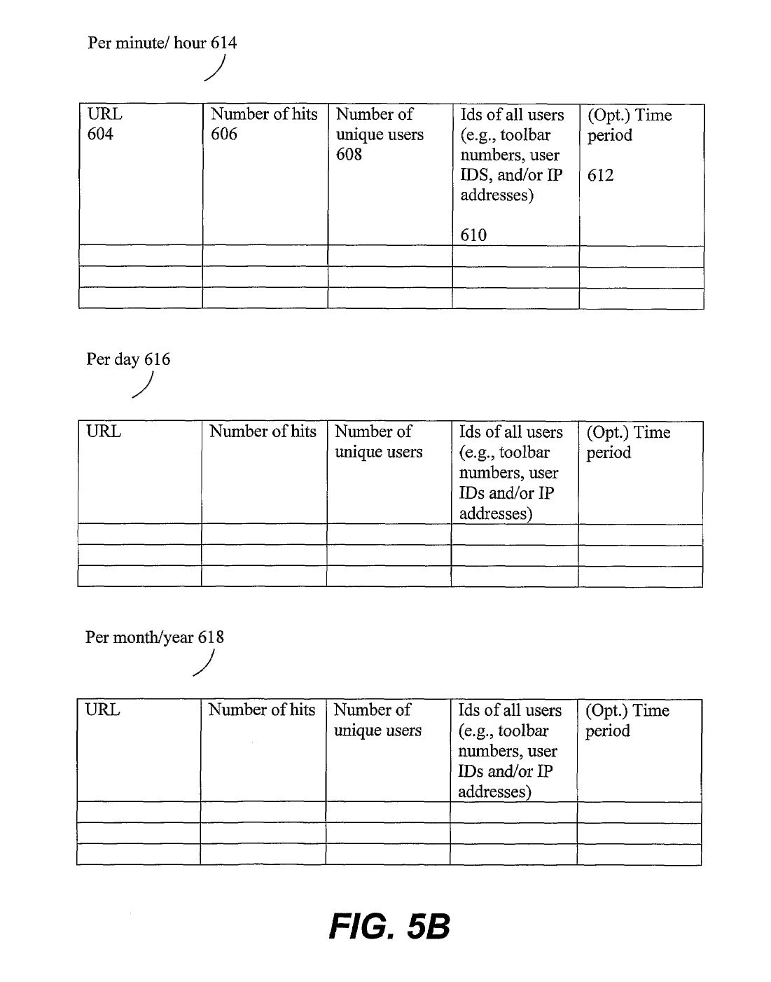

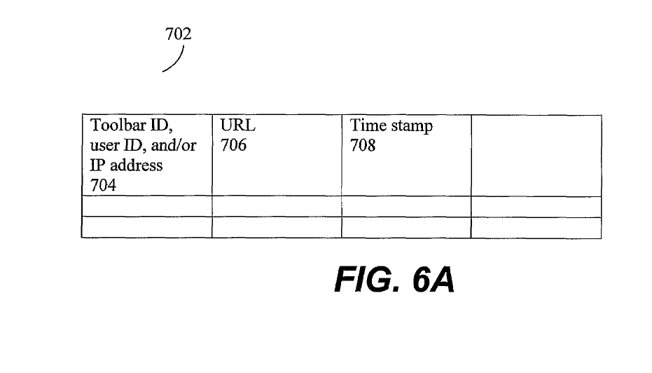

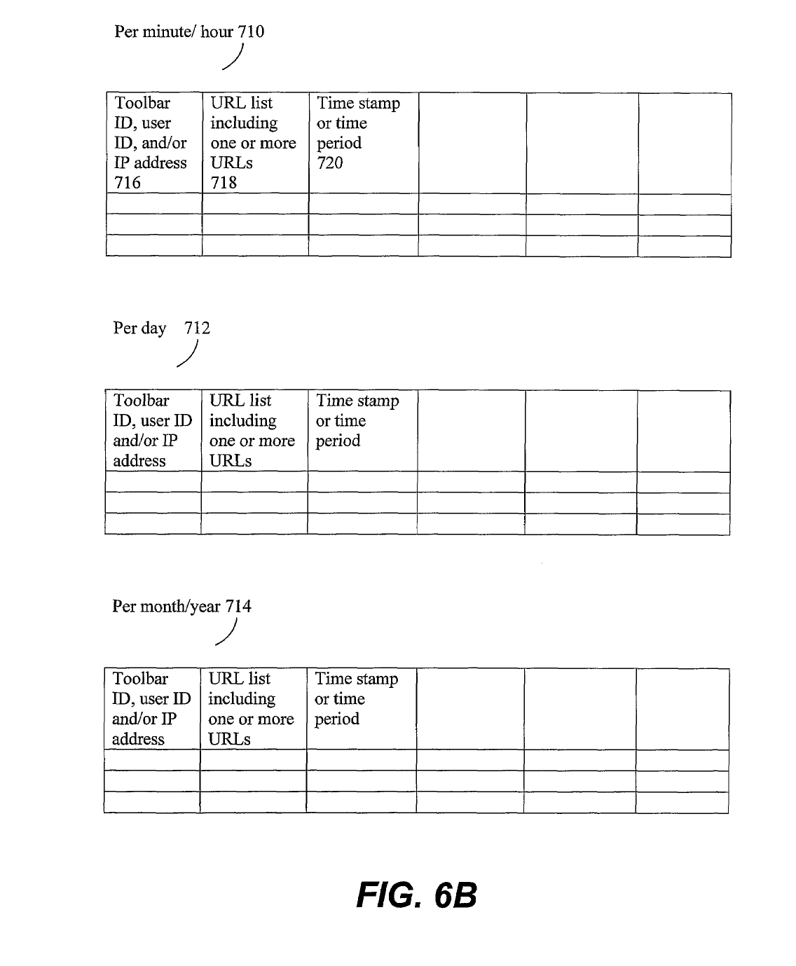

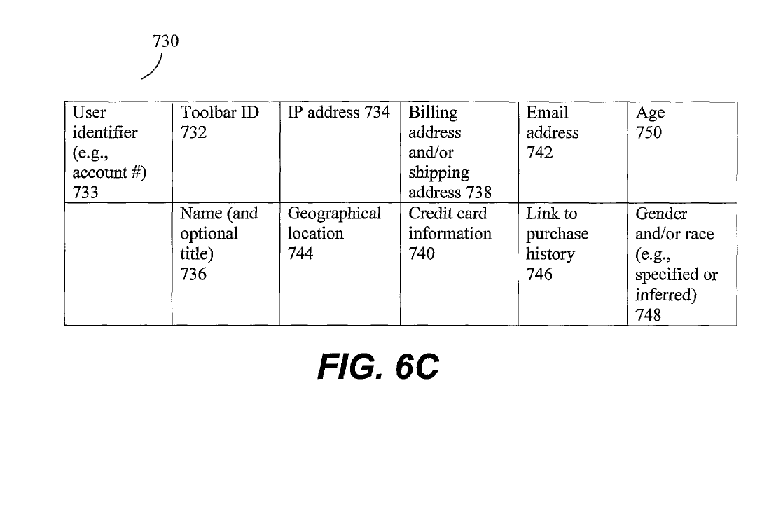

The information that is stored in the history database 304 may be stored in a variety of formats. Exemplary tables that may be used to store history data associated with multiple users and multiple URLs will be described in further detail below with reference to FIGS. 5A-5B and 6A-6B. In addition, an exemplary user record used to store a user's personal information will be described in further detail below with reference to FIG. 6C.

As set forth above, a recommendations database 304(b) may be accessed for use in generating a list of recommended or related links. An example of a system and method for generating a set of recommended links may be found in patent application Ser. No. 10/050,579, entitled “Web You Made,” filed on Jan. 5, 2002, which is incorporated herein by reference for all purposes. The Web You Made application discloses a technique for generating a list of recommended websites based at least in part upon a user's previously visited websites.

As suggested above, there are a wide variety of agents that may be used to generate the recommended links. A few have been discussed in some detail above, however any of a number of other specific agents could be provided to create recommended links that are perceived to be of interest to a user.

In one example, an Agent can be configured to recommend links that are related to web pages or websites stored in particular folders in a bookmark list. Much as a user may divide their bookmarks into one or more categories or separate them into one or more folders for organizational purposes, similarly one or more different recommended link lists may be presented to the user. Each folder or list of bookmarks presented in a bookmark list (as for example the bookmark list shown in FIG. 1A) may have an associated list of recommended links. As one example, a sports-related folder of bookmarks may have an associated set of sports related recommended links Some agents may be arranged to apply a geographic location limitation when generating a list of recommended links. For instance, in many instances a user may be particularly interested in businesses, events or organizations that are geographically close to the user. Therefore, an agent may use “geographical location” as one of the criteria when identifying related websites. It should be appreciated that the geographic location of a user may be ascertained from a number of sources. For example, the user's location may be available from registration information, billing or shipping information or the like. Alternatively, the user's general location can be automatically determined based on the IP address of the user (e.g., Akamai provides a mechanism for accurately mapping an IP address to a geographical location). Alternatively, the geographic region of interest to the user may be defined, for example, by entering a particular city, state, county, one or more zip codes, or a region have a radius of a specified number of miles around an identified center such as a particular landmark or address.

Another type of agent may restrict recommended links to those links that point to sites having particular content or are related to certain subject matter. For instance, links associated with a particular subject of interest to a user may be recommended to the user. The subject may, for example, be a category such as news, entertainment, movies, stocks, traffic, or sports. Alternatively, the subject may be defined by a rating (e.g., PG, R) of the content of the referenced site. Or, the subject may be a topic such as “bass fishing” that is very specific to the user. The subject of the websites that are being recommended may be identified by the top-level domain of the site or, alternatively, the content of the site based on keyword analysis or other prior categorization.

Still another type of agent may recommend links based on a status of the link. For instance, a website may achieve the status of a “mover and shaker” when it has reached a threshold level of popularity. The popularity of a website may be determined, for example, by the total number of hits received during a specified period of time or by the total number of unique users accessing the website during a specified period of time. Moreover, popularity may be ascertained by the number of times a particular user accesses the website during a specified period of time.

Often, a user (or a group of users) will typically visit certain particular websites or web pages at particular times of day or times of the year (e.g., morning, afternoon, evening, late night, weekday, weekend, hourly, at or around annual holidays, or during the time when specific sporting events are being held). Some agents may take the time of day or time of year into account when making recommendations. For example, some Agents may create separate lists of recommendations based on the time of day (e.g. one for the morning, one for the afternoon and one for the evening) or the time of year (e.g., a separate list during the Christmas holidays).

It is important to note that a user may be identified by one or more identifiers. For instance, a user may be identified by an IP address, user identifier (e.g., account number) and/or toolbar identifier. Since a user may have a toolbar installed on multiple, different computers, it may be desirable to uniquely identify each of these locations by a toolbar identifier. Thus, it is possible to track all web activity associated with the user via the user identifier (e.g., account number) associated with the user. Alternatively, it is possible to separately track web activity associated with a user at different locations via the corresponding toolbar identifier and/or IP address. In this manner, it is possible, for example, to separately track web activity associated with the user at work from a work computer and at home from a home computer. Accordingly, recommended links may be provided in accordance with the web activity of the user at these different locations.

Another agent may be arranged to recommend links based on an analysis of the browsing habits or bookmarks that are used by a group of users that a particular user is associated with. For instance, this group of users may be the user's family, a group of friends of the user, a group of friends of friends of the user, a company associated with the user, a club to which the user belongs, or an association to which the user belongs. For example, the user may define a list of friends, as well as other lists associated with different groups of users. A group-habit analyzing Agent may be arranged to recommend links based on an analysis of the websites or web pages that have been visited or bookmarked by others in the group. It may be desirable to provide only a subset of those websites that were either visited or bookmarked by at least one individual in the group. For instance, it may be desirable to establish a threshold number of visits or threshold visitation frequency by at least one individual in the group, a majority of the individuals in the group, or all individuals in the group. By way of example, one recommended links agent that provides recommendations based on the habits of a related group is described in Provisional Application No. 60/645,995 (A9XX-P001P), entitled: “Methods and Apparatus for Tracking Website Visitation Trends Among Discrete Sub-Populations” which is incorporated herein by reference.

Still other Agents may be configured to give the user control over some of the criteria that are used to generate the recommended links. This can give the user some ability to customize the nature of the recommendations provided. For example, when recommendations are based at least in part on historical browsing data, the user may be given the ability to edit the period of time over which the search history is analyzed and/or the total number of recent visits or page turns that are visited.

In other embodiments, certain agents may be configured to present a list of selectable criteria to the user. The list of selectable criteria may be generated by the entity performing the recommended link service, or may be customized by the user as described using the techniques below. From this list of criteria, the user may select those criteria to be applied to generate the list of recommended links. The user may select criteria, for example, by performing a drag-and-drop operation or by double-clicking on the criteria. Those criteria that are selected by the user are displayed in a list of selected criteria. In this example, the criteria that have been selected by the user include “singles dating sites,” “clubs in San Francisco,” “sites bookmarked in the last week by my family within 10 miles of me that relate to news sites,” and “sites bookmarked by my friends in the morning during weekdays that relate to traffic.”

If two or more criteria are added to the list of selected criteria, the user may be allowed to define how the criteria in the list are to be combined. For instance, a set of operators such as AND, OR, NOT, WITHIN, OUTSIDE, <, >, < >, /=, and = may be provided (not shown). The user may then select an appropriate operator to combine two or more different criteria for execution. In this manner, multiple criteria may be combined in a single statement for execution. In the absence of a user specifying one or more operators, a default operator (such as an “AND”) may be applied to the criteria in the list.

Once a list of recommended links and/or list(s) of bookmarks is generated, they can be shared or published for access by one or more users. Thus, a list of recommended links and/or list(s) of bookmarks may be presented to the user, as well as other individuals or groups of users. For instance, a user may wish to enable the recommended links or his or her list(s) of bookmarks (or portions thereof) to be viewable by friends or family. Moreover, users may be interested in viewing recommended links generated by the web activities of other similarly situated users or bookmarks that have been created by other similarly situated users. These similarly situated users may share a set of personal characteristics such as gender, age, employment status, race, etc or other characteristics such as geographic location. As another example, the user may have purchased one or more items, visited one or more URLs, or selected one or more bookmarks in common with at least one of the individuals. The set of characteristics may be pre-defined or may be selected by the user. In addition, a user's list of bookmarks may be published as the “list of the day.” Thus, one user's bookmarks may be presented as a list of recommended links to another individual, thereby enabling the individual to transfer any of these links to his or her list of bookmarks.

As described above, each of the agents includes one or more software modules that performs tasks in accordance with criteria that may be set by the user. The agents may be used separately or in combination with one another in order to generate a list of recommended links. These criteria may be selectable by a user, as well as configured with the desired values (e.g., distances, ages). In this manner, the user may control the quality of links that are presented to the user as recommended links.

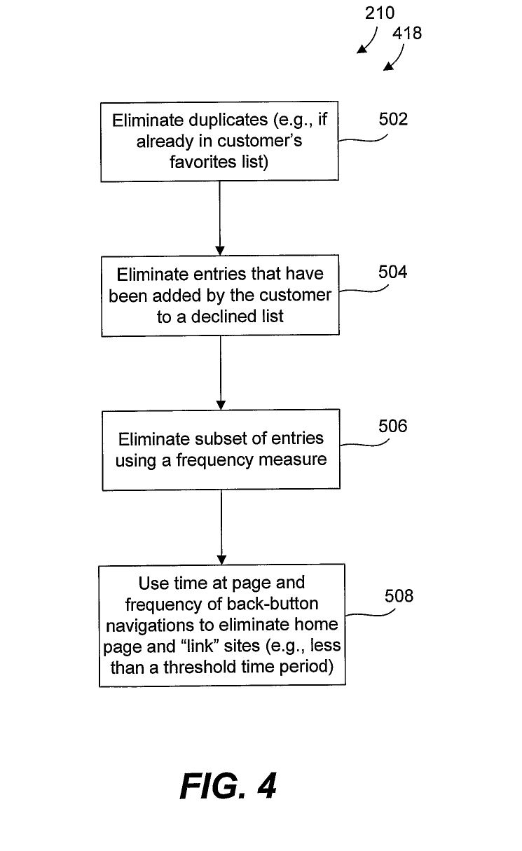

It is important to note that the agents may be executed in batch mode. For instance, a set of agents may be executed for a single customer as set forth below with reference to FIG. 4A. Alternatively, agents may be executed in batch mode, where each agent executes for a set of customers. In this manner, agents may be executed at regular intervals to conserve processing time.

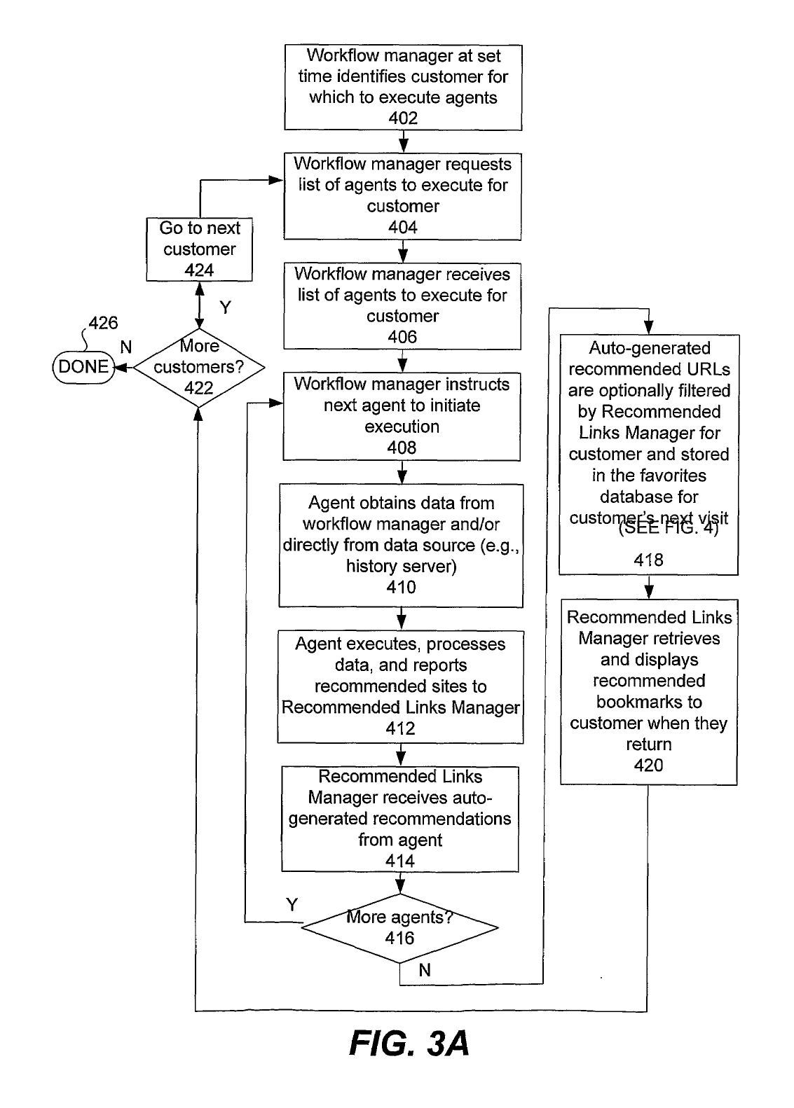

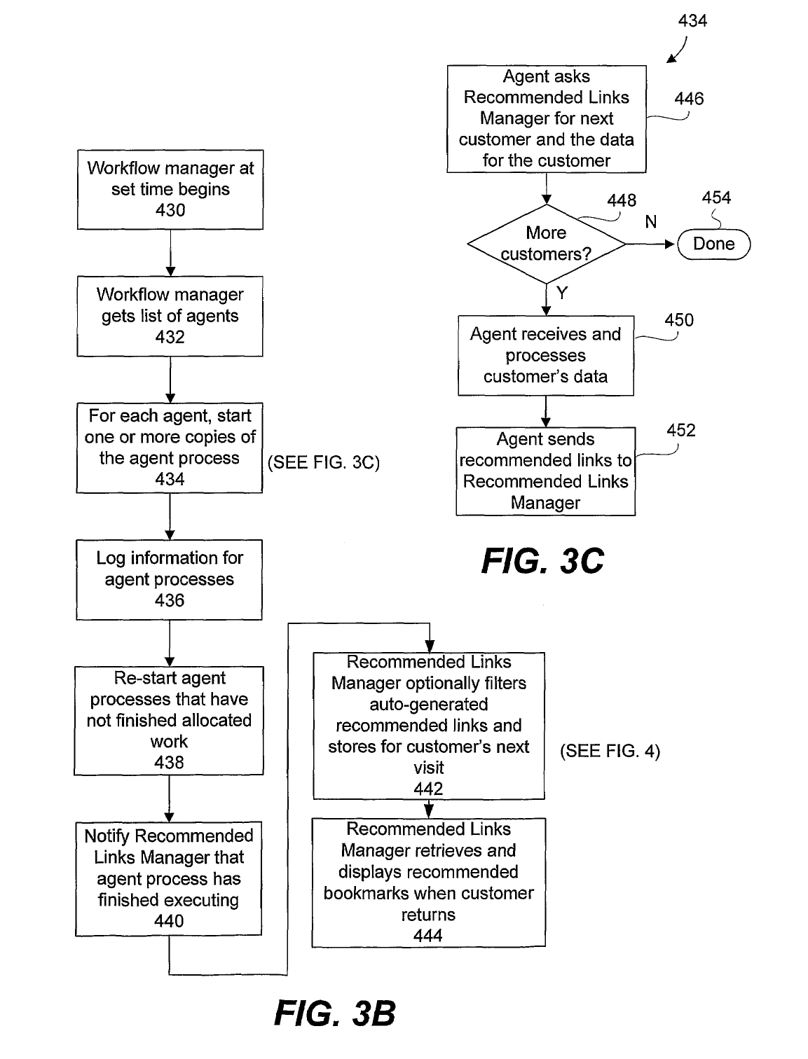

FIG. 3A is a process flow diagram illustrating a method of executing multiple agents by a workflow manager such as that shown in FIG. 2 in accordance with one embodiment of the invention. The workflow manager at a set time identifies a customer for which to execute a set of agents at block 402. The workflow manager requests a list of agents to execute for the customer at block 404 and receives the list of agents at block 406. The workflow manager identifies the appropriate order in which to execute the agents and instructs the next agent to initiate execution at block 408. The agent may obtain data from the workflow manager and/or directly from one or more data sources (e.g., history database) at block 410. For instance, the workflow manager may obtain data that will be common to multiple agents, while each agent may retrieve data particular to that agent directly from a data source.

When an agent executes, it processes the pertinent data and reports a list of recommended sites to the recommended links manager at block 412. The recommended links manager receives the auto-generated recommendations from the agent at block 414. For each remaining agent at block 416, the workflow manager continues to initiate execution of the remaining agents at block 408.

When all agents have been executed for the customer, the auto-generated recommended links may be filtered for the customer by the recommended links manager and stored in the database for the customer's next visit at block 418. For instance, filtering may involve removing blocked bookmarks that are presented to the user as recommended bookmarks. One method of filtering auto-generated recommended links will be described in further detail below with reference to FIG. 4. Once filtered, the recommended links manager retrieves and displays the recommended links to the customer upon their return to the website at block 420.

If there are more customers for which agents are to be executed at block 422, the process repeats for the next customer at block 424 and the workflow manager continues to execute at block 404. When no customers remain, the process ends at block 426.

FIG. 3B is a process flow diagram illustrating an alternate method of executing multiple agents by a workflow manager such as that shown in FIG. 2 in accordance with another embodiment of the invention. As shown at block 430, the workflow manager at a set time begins executing. The workflow manager obtains a list of agents to execute at block 432. For each agent, the workflow manager initiates execution of the agent. Specifically, the workflow manager starts one or more copies (e.g., instantiations) of the agent process at block 434. In addition, the workflow manager may also log information such as state information at block 436 for the agent processes. In addition, the workflow manager monitors the state of completion of each of the agents, and restarts any agent processes that have not finished their allocated work, as appropriate, as shown at block 438.

Upon completion of execution of an agent process, the workflow manager notifies the recommended links manager that the agent process has finished executing at block 440. The recommended links manager optionally filters auto-generated recommended links and stores the recommended links for the customer's next visit at block 442. One process of filtering recommended links will be described in further detail below with reference to FIG. 4. The recommended links manager then retrieves and displays the recommended bookmarks when the customer returns at block 444.

FIG. 3C is a process flow diagram illustrating a method of executing an agent as shown at block 434 of FIG. 3B. When an agent initiates execution, it asks the recommended links manager for the next customer and the data for the next customer at block 446. If there are more customers remaining to be processed at block 448, the agent receives and processes the customer's data at block 450, and sends the recommended links to the recommended links manager at block 452. When there are no customers remaining to be processed, the agent process ends at block 454.

As described above with reference to block 450, the agent receives and processes the customer's data. This processing may simply involve receiving recommended links or categories thereof from another source and providing these to the user. Alternatively, the processing may involve processing data prior to providing recommendations to the user.

FIG. 4 is a process flow diagram illustrating a method of filtering auto-generated recommended links as shown at block 418 of FIG. 3. Generally, it will be desirable to eliminate recommended links from the list if they have already been added to the user's list of bookmarks as shown at block 502. Similarly, if the user has previously added a recommended link to a “blocked” list of links, the declined recommended link will be eliminated from the list of recommended links at block 504. It may also be desirable to eliminate a subset of recommended links if they fail to meet a particular frequency measure at block 506. For instance, a URL corresponding to a particular recommended link may not have been accessed by the user (or another user or group of users) at the desired threshold frequency (e.g., within a particular period of time). Moreover, a site that is merely a “link” site or a home page may be eliminated from the list of recommended links at block 508. Specifically, it is possible to analyze the time spent at a particular URL by a user. When the time spent is less than a threshold time period, that URL may be either a home page or a “link” site. It may also be desirable to monitor other selections by the user, such as the frequency of back-button navigations, for this reason. Other websites that are universally popular sites such as Yahoo may also be removed from the recommended links.

As described above, the history database may store data associated with multiple URLs and users. In accordance with one embodiment, the data is stored in URL tables and user tables. The URL tables support access to data using the URL as the primary key, while the user tables support access using a user identifier (e.g., account number, toolbar identifier and/or IP address) as the primary key.

FIG. 5A is a diagram illustrating an exemplary URL table that may be used to store website visitation data in accordance with one embodiment of the invention. As shown, the exemplary URL table 602 includes a plurality of entries 603. Each of the entries 603 is associated with a URL 604 (which may be identified in the entry), and identifies a number of hits 606 that have been received by the URL, the number of hits by unique users 608, the identities of the users 610 (e.g., toolbar numbers, user identifiers and/or IP addresses), and the relevant time stamp or time period 612. In this manner, data may be retrieved and stored each time a user accesses a particular web page. In accordance with one embodiment, a different URL table is associated with each URL.

The identity of a user may be established by at least one identifier. In accordance with one embodiment, a user may have an IP address and/or toolbar identifier. Moreover, a single user may have a different toolbar identifier for each computer on which a toolbar is installed. This is particularly desirable since a user may search for different websites at a home computer than at a work computer. As a result, it is possible to track activities of users at different locations or times of the day.

In order to summarize data for efficient retrieval, URL summary tables may be built or updated. For instance, each URL summary table may include data “summarized” over a particular time period. An exemplary URL summary table will be described in further detail below with reference to FIG. 5B.

FIG. 5B is a diagram illustrating exemplary URL summary tables composed from one or more URL tables in accordance with one embodiment of the invention. As described above, each URL may be identified in an entry in a URL table. Alternatively, a different URL table may be established for each URL. In order to enable data to be efficiently retrieved, the data stored in one or more URL tables is summarized in multiple URL summary tables. For instance, data associated with multiple timestamps may be summarized over a particular time period. As one example, the number of hits may be totaled for a URL during the period of an hour. Alternatively, a URL summary table associated with the particular time period (e.g., hour) may include all entries storing data representative of all web activity occurring during that time period. In other words, the URL summary tables may merely reorganize the data in the URL tables (rather than provide a “summary”).

In a URL summary table, data for a particular URL may be summarized over various time periods, such as per minute, hour, day, month or year. As described above, the URL 604 may be identified in the entry in a URL summary table. In the URL hourly summary table 614, data is summarized for each hour. For instance, each entry in the table may represent a different hour. In other words, the number of hits 606, number of unique users 608, and one or more user identifiers 610 (e.g., toolbar numbers, user identifiers and/or IP addresses) identifying the users who have accessed the URL together represents the web activity of users who accessed the URL during a specified hour long time period 612. Similarly, URL summary tables may be updated and maintained with summary data over periods of one or more days 616, or one or more months (or years) 618.

Data associated with a particular URL may be obtained from the appropriate URL or URL summary tables. Specifically, the URL may be used as a primary key. However, it may also be desirable to obtain data for a particular user (e.g., user identifier, toolbar identifier and/or IP address). Exemplary user and user summary tables will be described in further detail below with reference to FIGS. 6A and 6B.

FIG. 6A is a diagram illustrating an exemplary user table 702 that may be used to store data associated with a user in accordance with one embodiment of the invention. In accordance with one embodiment, when data is obtained from the toolbar, at least one identifier associated with the user and a URL that the user is accessing are obtained. Specifically, the identifier(s) (e.g., user identifier, toolbar identifier and/or IP address) and the URL may be identified via the toolbar. The user table 702 is then updated with at least one identifier 704 and the URL 706, as well as a timestamp 708 to indicate that the user has accessed the URL 706 at the time indicated by the timestamp 708. Specifically, the identifier(s) 704 may include a user identifier (e.g., account number), toolbar identifier and/or IP address. The timestamp 708 may include a time, as well as a date. In this example, the toolbar identifier or user identifier may be used as the primary key.

Similarly, user summary tables may be built or updated. For instance, each user summary table may include data “summarized” over a particular time period. An exemplary user summary table will be described in further detail below with reference to FIG. 6B.

FIG. 6B is a diagram illustrating an exemplary user summary table composed from various user tables in accordance with one embodiment of the invention. As described above, each user (e.g., identified by a user identifier or toolbar identifier) may be identified in an entry in a user table. Alternatively, a different user table may be established for each user. In order to enable data to be efficiently retrieved, the data stored in one or more user tables is summarized in multiple user summary tables. For instance, data associated with multiple timestamps may be summarized over a particular time period.

In a user summary table, data for a particular user may be summarized over various time periods, such as per minute, hour, day, month or year. In the user hourly summary table 710, data is summarized for each hour. For instance, each entry in the table may represent a different hour. Similarly, in the user daily summary table 712, data is summarized for each day, while data is summarized for each month (or year) in the monthly (or annual) summary table 714. In this manner, data may be summarized for each user. Alternatively, in accordance with another embodiment, a user summary table associated with the particular time period (e.g., hour) may include all entries storing data representative of web activity occurring during that time period. In other words, the data may merely be re-organized rather than “summarized.”

Data in the user summary tables may be updated and maintained with summary data over periods of one or more hours 710, one or more days 712, or one or more months (or years) 714, for example. In each summary table, each entry summarizes the activity of a particular user over the specified time period. For instance, a single entry may identify a toolbar identifier, user identifier and/or IP address 716, a URL list 718 of one or more URLs accessed during the specified time period, and the applicable time period (or timestamp) 720. In this manner, the activity of a particular user over a specified time period may be easily accessed.

Data associated with a particular user may be obtained from the appropriate user or user summary tables. Specifically, the toolbar identifier (or user identifier) may be used as a primary key.

As described above, one or more identifiers (e.g., toolbar identifier, user identifier and/or IP address) may be used to identify a particular user or toolbar. Such an identifier may also be further linked to information associated with the user.

Information associated with the user may be obtained via the website during a registration process. For instance, personal information is generally collected when a new account is established. During the registration process, the website provider may obtain various consumer data such as socio-economic data and address information identifying a geographic region (e.g., zip code) within which the consumer lives or works. In addition, the consumer may enter a title, first name, last name, an electronic mail address, a password, and address information including a specific address and/or city, state and zip code. In addition, socio-economic data including gender, race, occupation, salary, and education level may be obtained. In addition, at the time of registration, a user identifier (e.g., account number) may be assigned.

FIG. 6C is a diagram illustrating an exemplary user record including personal information associated with a user. The user record 730 associated with a user will generally include one or more identifiers identifying the user and/or an associated toolbar. For instance, a toolbar identifier 732, user identifier (e.g., account number) 733 and/or IP address 734 may be used to identify both a user and a specific toolbar (e.g., computer location). In addition, a name 736 associated with the user may be specified, which may also include a title (such as Mr. or Mrs.). Additional information may include a billing address 738 (and shipping address), credit card information (e.g., credit card number) 740, and email address 742.

A geographical location 744 may also be specified by the user or ascertained from information such as the user's IP address (e.g., where a billing address or shipping address is not specified for the user), as described above.

Other information stored in a user record may include a link to the purchase history 746 of the user. In addition, the gender and/or race 748 may be specified by the user. Alternatively, the gender may be inferred from the name or title of the user. In addition, other information such as the user's age 750, employer (not shown), e-mail provider (not shown), school (not shown), and birthplace (not shown) may also be stored in the user record 730.

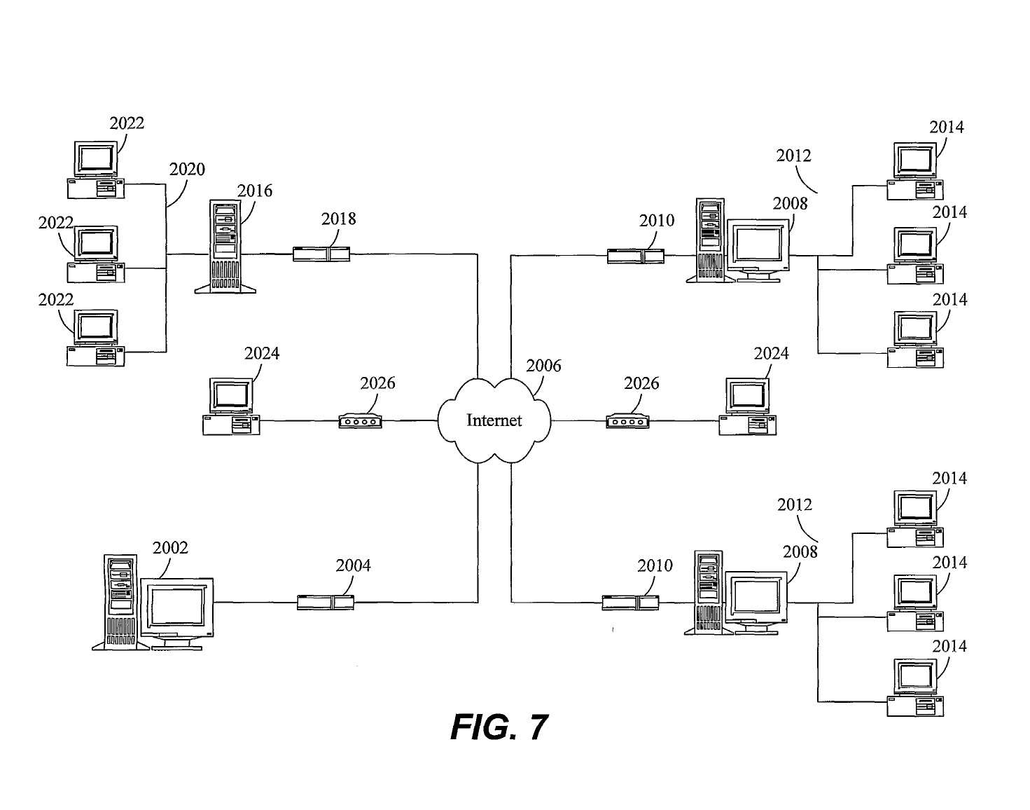

FIG. 7 is a block diagram of a hardware environment in which the various embodiments of the present invention may be implemented. The website at which data is collected, stored, retrieved, and analyzed in order to generate lists of recommended links is located on a server 2002 which is connected by a router 2004 to the Internet 2006. Users located at businesses (represented by servers 2008) may also be connected to the Internet via routers 2010 in order to receive the transmission of one or more lists of recommended links from the server 2002. Business servers 2008 may have networks 2012 associated therewith interconnecting a plurality of personal computers or work stations 2014. Users (represented by computers 2022 and 2024) may be connected to the Internet in a variety of ways. For example, a user may be connected from his home via a modem 2026, or from his workplace via a network 2020, a file server 2016, and a router 2018. As described above, a different toolbar identifier may be associated with each computer that the user accesses. It is therefore possible to separately track a user's web activities occurring at home and work. It will be understood that, according to various embodiments of the invention, users may gain access to the website on server 2002 via a variety of hardware configurations. Similarly, businesses may be coupled to the website on server 2002 in order to receive the transmission of communications as well as data from the website. For example, a business may consist of an individual on his home computer 2024. Similarly, a user may be an employee who accesses the website from his computer 2014 at his place of employment, which is a business. It will also be understood that the hardware environment of FIG. 9 is shown for illustrative purposes and that a wide variety of hardware environments may be employed to implement the various embodiments of the present invention. It should also be understood that specific embodiments of the methods and processes described herein are implemented as computer program instructions, i.e., software, in the memory of server 2002. In addition, the disclosed embodiments may be implemented in a peer-to-peer or other distributed system.

Various embodiments of the invention can also be embodied as computer readable code on a computer readable medium. The computer readable medium is any data storage device that can store data, which can thereafter be read by a computer system. Examples of the computer readable medium include read-only memory, random-access memory, CD-ROMs, magnetic tape, and optical data storage devices.

Although illustrative embodiments and applications of this invention are shown and described herein, many variations and modifications are possible which remain within the concept, scope, and spirit of the invention, and these variations would become embodiments of the present invention support the generation of lists of recommended links based upon data that satisfies specific criteria. Various exemplary criteria are set forth, which may be used individually or in combination with one another. However, it should be understood that the disclosed criteria are merely illustrative, and therefore the disclosed embodiments may be implemented with data retrieved and/or analyzed based upon other criteria, or combinations thereof. For instance, although some of the described embodiments refer to recommended links (e.g., URLs), a recommendation list of may instead reference one or more categories of recommended links. In such an arrangement, each category may include any number of recommended links. Accordingly, the present embodiments are to be considered as illustrative and not restrictive, and the invention is not to be limited to the details given herein, but may be modified within the scope and equivalents of the appended claims.

While the preferred embodiment of the invention has been illustrated and described, it will be appreciated that various changes can be made therein without departing from the spirit and scope of the invention.

1. An architecture for object-oriented software for a QKD system having first and second QKD stations (nodes) that enables a user to remotely control a remote one of the nodes from a local one of the nodes, comprising:
a graphical user interface (GUI) at the local node that allows the user to control the operation of both local and remote QKD stations via secure link connecting the nodes;
a calibration family of objects in each node that includes software made up of algorithms, functions, and data to support initialization, stabilization and/or calibration procedures and the GUI; and
a card family of objects in each node that includes software constructs made up of algorithms, functions, and data adapted to interface calibration software with physical components in each node so as to effectuate QKD system initialization and/or stabilization and/or calibration from the local node.

2. A method of controlling nodes of a QKD system after the QKD system is deployed, comprising:
providing each node with the architecture of claim 1;
deploying each node;
identifying a local node and a remote node; and
controlling both the local node and a remote node via the GUI on the local node to effectuate at least one of initialization, stabilization and calibration of the nodes of the QKD system.

3. A method of deploying a QKD system, comprising:
providing each node in the QKD system with software adapted to perform initialization, stabilization and calibration, procedures at the corresponding node and support a graphical user interface (GUI) at a local node;
operating the software at the local and remote nodes via the GUI at the local node so as to initialize and/or stabilize and/or calibrate the QKD system.

4. A QKD system comprising:
first and second nodes each having control software adapted to control the operation of the corresponding node to perform system initialization and/or stabilization and/or calibration, the first and second nodes operably coupled by a secure communication link, wherein the first node is a local node and the second node is a remote node;
a graphical user interface (GUI) that represents respective operating states of the first and second nodes; and
a local client proximate to and operatively coupled to the local node and adapted to display the GUI and effectuate control of the local and remote nodes via said software.

5. The method of claim 2, wherein performing stabilization includes performing at least one stabilization procedure selected from the group of stabilization procedures comprising: setting a Q-laser bias, setting a Q-laser pulse width, setting a Q-laser timing, setting a temperature of a single-photon detector (SPD), setting an SPD sensitivity level, determining a modulator timing, setting a modulator voltage, setting up a sync laser, and setting a synchronization lock.

6. The method of claim 3, wherein performing stabilization includes performing at least one stabilization procedure selected from the group of stabilization procedures comprising: setting a Q-laser bias, setting a Q-laser pulse width, setting a Q-laser timing, setting a temperature of a single-photon detector (SPD), setting an SPD sensitivity level, determining a modulator timing, setting a modulator voltage, setting up a sync laser, and setting a synchronization lock.

7. The system of claim 4, wherein the local node is adapted to perform at least one stabilization procedure selected from the group of stabilization procedures comprising: setting a Q-laser bias, setting a Q-laser pulse width, setting a Q-laser timing, setting a temperature of a single-photon detector (SPD), setting an SPD sensitivity level, determining a modulator timing, setting a modulator voltage, setting up a sync laser, and setting a synchronization lock.
